(19) United States
(12) Patent Application Publication
(10) Pub. No.: US 2026/0139156 A1
(43) Pub. Date: May 21, 2026

(54) CHEMICAL POLISHING BATH FOR TITANIUM AND TITANIUM ALLOYS, AND METHOD USING SUCH A BATH

(71) Applicant: INSTITUT DE RECHERCHE TECHNOLOGIQUE MATÉRIAUX MÉTALLURGIE ET PROCÉDÉS, Metz (FR)

(72) Inventors: Jérôme FRAYRET, Le Triadou (FR); Joffrey TARDELLI, Bertrange (FR)

(73) Assignee: INSTITUT DE RECHERCHE TECHNOLOGIQUE MATERIAUX METALLURGIE ET PROCEDES, Metz (FR)

(21) Appl. No.: 19/120,183

(22) PCT Filed: Sep. 29, 2023
(86) PCT No.: PCT/EP2023/077153

§ 371 Date: Apr. 10, 2025

(30) Foreign Application Priority Data
Oct. 14, 2022 (FR) FR2210635

(51) Int. Cl. C09G 1/04; B33Y 40/20; C23F 3/06

(52) U.S. Cl. CPC C09G 1/04; B33Y 40/20; C23F 3/06

(57) ABSTRACT

The invention relates to a chemical polishing bath for polishing a titanium or titanium alloy component, or a part thereof, which chemical polishing bath comprises water, a fluoride complexing agent capable of forming a complex with oxidized titanium at an equivalent fluoride concentration of between 1.40 and 2.80 mol/L, phosphoric acid in a concentration of between 3 and 6 mol/L, together with sulfuric acid in a concentration of between 0.5 and 1.5 mol/L.

The bath is particularly well suited to polishing components obtained from additive manufacturing (3D printing).

### FIELD OF THE INVENTION

The present invention relates generally to the field of surface treatment of titanium or titanium alloy components, and in particular to the field of polishing titanium or titanium alloy components. The invention is particularly intended for polishing components produced by additive manufacturing.

### BACKGROUND OF THE INVENTION

Additive manufacturing or 3D printing, which enables the production of three-dimensional polymeric or metallic components from powders, constitutes a major focus of R&D in France and throughout the world. By successively fusing powders, additive manufacturing methods make it possible not only to produce components of complex geometry but also to contemplate the production of new alloy grades that are not obtainable by traditional metallurgical methods, while limiting the quantities of raw material required. Additive manufacturing is a technology of particular interest to the aerospace, automotive or shipbuilding industries from the viewpoint of improving the performance and reducing the weight of structures. However, “powder bed” additive manufacturing methods intrinsically lead to the creation of components, the final surface state of which bears traces of having being produced from powders with, in particular, surface roughness values expressed by the parameter Ra of between 5 and 25 μm depending on the method used, namely substantially greater than the roughness of a machined component (of the order of several microns). Moreover, the components produced are generally characterized by the presence of partially melted particles on the outer surface which may become detached in service and so impair performance of these components (blocking pipes, entraining particles into hydraulic systems, reducing static and dynamic mechanical properties etc.).

It is therefore necessary not only to decrease the roughness of the components resulting from additive manufacturing, but also to eliminate surface irregularities and so prevent the risk of particles/foreign bodies becoming separated from the surface when in service, which could bring about functional problems in relation to the use of these components. Improving the surface state of the components produced may also allow improvement in certain aspects of performance in terms of fatigue strength and corrosion resistance, or indeed surface flow when it comes to hydraulic applications.

Currently, such a post-treatment step is a major technological obstacle with regard to the development of functional metallic components with controlled, reproducible characteristics resulting from additive manufacturing.

There are various polishing methods, such as electropolishing or plasma or laser polishing but these methods require the use of electrical current or indeed lasers, leading to high secondary costs. Furthermore, the use of lasers or working with high electric intensities require special protection for the operator. Finally, these complex methods require precise control of their parameters. As far as electropolishing baths are concerned, these are also difficult to manage because they are very hygroscopic and periodic dehydration steps are needed.

“Chemical” polishing methods consisting of immersing the component to be treated in a bath, or “chemical polishing bath”, containing acidic or basic compounds together with oxidizing agents, are simpler to implement and do not require the application of an electric current or a laser.

One example of a chemical polishing method is described for example in document CN 105 297 026 A that discloses the use of a bath comprising at least one vegetable oil, two oxidizing agents in the form of nitric acid and hydrogen peroxide, and a complexing agent in the form of hydrofluoric acid. In addition to its complexity, this bath has the drawback of using strong oxidizing and complexing agents for titanium which quickly attack the surface of a titanium component to be polished, and the boundary between polishing and machining is fuzzy when such a bath is used. Furthermore, it requires the handling of hydrofluoric acid, which is extremely corrosive and toxic, such that implementing such a polishing bath requires the implementation of special protective measures for operators.

The object of the invention is to provide a polishing bath for titanium or titanium alloy components which does not have the above-mentioned drawbacks and which makes it possible to obtain a surface having an average roughness (expressed by the parameter Sa) of typically less than 4 or 5 μm and limited material removal, typically of less than 300 to 350 μm.

### GENERAL DESCRIPTION OF THE INVENTION

With this object in mind, the present invention relates to a chemical polishing bath for titanium and titanium alloy components, and to a method using such a bath.

The objective of chemical polishing is to reduce the surface roughness of a metallic component by carrying out selective dissolution of a layer of material of variable thickness that may range from around ten nanometers to a number of tens of micrometers. This material removal is performed chemically using reagents that may be acidic or basic in nature but also have oxidizing properties. It should be noted that the dissolution caused by the chemical polishing method has a direct impact on the dimensional aspect of the component even if this is not the objective sought, something which distinguishes it from the chemical machining method, the sole objective of which is to reduce the dimensions of the component (by a number of tens or hundreds of microns), so as to achieve a target value.

The principle of chemical polishing is also different from that of chemical pickling, which is closer to a chemical machining method. This is because the objective of chemical pickling is to remove an oxide layer, the thickness of which is of the order of a few microns, without impacting the dimensional features of the component and its surface roughness but promoting adhesion of the subsequently applied surface treatment.

A difference may also be noted in relation to the chemical degreasing/decontamination steps aimed at solubilizing any chemical species adsorbed on the surface of the material to be treated. No impact on the dimensional characteristics of the component is observed in this latter case.

Thus, in the present text, polishing is taken to mean decreasing the surface roughness of a component while modifying its dimensions as little as possible.

According to the invention, a chemical polishing bath for polishing a titanium or titanium alloy component, or a part thereof, comprises:
water;
a fluoride complexing agent capable of forming a complex with oxidized titanium at an equivalent fluoride concentration of between 1.40 and 2.80 mol/L;
phosphoric acid in a concentration of between 3.0 and 6.0 mol/L (namely between 290 and 590 g/L); and
sulfuric acid in a concentration of between 0.5 and 1.5 mol/L (namely between 50 and 150 g/L).

The present chemical polishing bath therefore takes the form of an aqueous solution having an elevated concentration of acids. Thus, the pH of a bath according to the invention is less than 2.0, preferably less than 1.0, particularly preferably a bath according to the invention has a negative pH. Advantageously, the concentration of phosphoric acid and sulfuric acid are such that the pH of a bath according to the invention is negative and remains negative during use of the bath despite the acids being consumed during polishing of the titanium or titanium alloy components.

One of the advantages of the invention is to have identified compounds, and their respective concentrations, that allow roughness to be significantly diminished without significantly increasing size reduction, whereas these two effects generally require conflicting parameters.

The solution according to the invention comprises two acids and a titanium oxide complexing agent. The density of the bath is controlled by the mixture of sulfuric acid and phosphoric acid. This is because, in order to obtain a polishing effect, the present bath has a viscosity, or density, that is generally greater than that of other solutions used for chemical attack, for example those of the chemical machining type. Thus, the aggressiveness of the present solution is different from conventional chemical pickling or machining solutions, despite the use of reagents which may be similar.

Sulfuric acid, like phosphoric acid, has oxidizing properties, although these acids are not generally considered oxidizing agents, unlike nitric acid, for example. The oxidizing properties of sulfuric and phosphoric acids are however sufficient for oxidizing the surface of a titanium or titanium alloy component. This is because titanium is a metal that is highly sensitive to oxidation. Thus, and advantageously, no oxidizing agent other than sulfuric acid and phosphoric acid is added to the polishing bath according to the invention in preferred embodiments.

The greater viscosity of the polishing solution makes it possible to slow down the diffusion phenomena of the chemical species of the solution toward the surface of the component where they are consumed. The objective is to make diffusion slower than the reaction kinetics. The attacking agents (sulfuric acid or phosphoric acid) and complexing agents are thus depleted at the surface because they are consumed faster than they can arrive at the surface. They therefore arrive first near the summits of the reliefs on the surfaces to be polished where they will primarily act. In contrast, the troughs will not see as many reagents (attacking agents and complexing agents), as these have already been consumed by a reaction on the highest relief points of the component. This phenomenon is thus responsible for a surface polishing effect achieved by selective dissolution of the rough surface areas.

In the context of the invention, speaking of an increase in the viscosity of the bath is equivalent to speaking of an increase in its density, and vice versa.

As the invention is currently understood, the effectiveness of the present chemical polishing bath resides in control of the diffusion kinetics of the sulfuric and phosphoric acids and the complexing agents within the bath toward the surface of the component to be polished, together with the reaction kinetics of the acids with the surface of the component to be polished. The principle of action of the chemical polishing bath according to the invention is as follows. An appropriate viscosity of the chemical polishing bath (increased relative to conventional chemical attack baths) makes it possible to slow down the diffusion phenomena of the active chemical species (here the acids—sulfuric and phosphoric—and complexing agents) of the solution toward the surface of the component. In the vicinity of the surface, the active species are consumed, which brings about local depletion of the bath. In order to re-establish equilibrium of the concentrations, the active species diffuse from the bath toward the surface, and in so doing they react as soon as they enter into contact with the surface to be polished. The most accessible zones being the summits of the peaks causing the surface roughness, attack of these summits is favored, so enabling the surface relief, and therefore the overall roughness of the component, to be reduced.

Initial tests were performed with the present polishing bath, for bath volumes of between 100 mL and 600 L, and proved effective. The chemical polishing bath according to the invention was developed in particular for polishing components resulting from additive manufacturing methods, but may be applied to all kinds of titanium or titanium alloy components, however they were obtained. Furthermore, the dimensions and/or geometries may be very varied. Moreover, the titanium component to be treated may be part of an element. That is to say, the titanium part to be treated may be combined with another material, against which it is juxtaposed or on which it is superposed.

Preferred fluoride complexing agents take the form of a fluoride salt. In other words, hydrofluoric acid as such is not used as a source of fluoride. However, the present invention does not rule out the formation of hydrofluoric acid in the bath as a result of the dissolution of these salts. Hydrofluoric acid is highly aggressive toward titanium, whereas the addition of a fluoride salt purely has a complexing action. Furthermore, using a fluoride salt makes the solution less hazardous to prepare. In other words, the fluoride complexing agent is advantageously added to the solution in salt form, and not in the form of pure hydrofluoric acid because the salts are less hazardous to handle.

Advantageously, the fluoride complexing agent added to chemical polishing bath is selected from NH₄F, NH₄F·HF, NaF, NaF·HF, KF, KF·HF, H₂TiF₆, H₂SiF₆ or mixtures thereof. The role of the fluoride complexing agent in the invention is to combine with the oxidized titanium (in the form of hydrated titanium oxide, in particular in the form of TiO₂, TiO(OH)₂ and/or Ti(OH)₄) that forms at the surface of the component in the presence of sulfuric and phosphoric acids, or which may be in solution.

Preferred fluoride complexing agents take the form of a fluoride salt and hydrofluoric acid. In other words, it is a weak acid in the presence of its anion, the fluoride ion or F⁻. Thus, the complexing agent used also acts as a buffer, which makes it possible to control the pH of the chemical polishing bath.

Furthermore, the fluoride ions (or F⁻) are capable of complexing a variety of metals, which is of interest in the case of titanium alloy components. Moreover, fluorides are complexing agents that are extremely stable in solution, and the risk of their breaking down over time and forming poorly controlled secondary products is minimal.

Depending on the variant, the fluoride complexing agent is present in a concentration of between 1.74 and 2.46 mol/L, preferably between 1.80 and 2.20 mol/L.

Depending on the variant, the phosphoric acid is present in a concentration of between 4.0 and 5.5 mol/L, namely between 390 and 540 g/L, preferably between 4.5 and 5.0 mol/L, namely between 440 and 490 g/L.

Depending on the variant, the sulfuric acid has a concentration of between 0.50 and 1.25 mol/L, namely between 50 and 125 g/L), preferably a concentration of between 0.80 and 1.02 mol/L, namely between 80 and 100 g/L.

During use thereof, the polishing bath becomes charged with dissolved titanium, due to the chemical attack acting on the surface roughness. It is possible to regenerate such a bath after use by simple addition of the compounds consumed during polishing (i.e., the acids and complexing agents) and in this case the regenerated bath still contains titanium, which is also the case for traditional chemical polishing baths. However, traditional baths are destroyed when the concentration of titanium becomes too high. This is because the presence of titanium may disrupt operation of the bath, and impair polishing performance, which results in particular in a deceleration of the reaction kinetics, which could have a negative effect on the polishing principle, and competition with the diffusion of the reagents (oxidizing agents and complexing agents). It is therefore preferable to define admissible titanium concentration limits which do not impair the chemical polishing mechanism. Advantageously, the titanium is present in a concentration ranging from approximately 2 to 35 g/L, namely between 0.04 and 0.73 mol/L, preferably in a concentration of ranging from approximately 10 to 30 g/L, namely between 0.20 and 0.63 mol/L.

Dissolved titanium accumulates in the bath during use of the present chemical polishing bath according to a concentration gradient from the surface of the component to be polished toward the volume of the bath. The highest titanium concentration close to the surface of the component to be polished advantageously also increases viscosity in this zone. Thus, the viscosity of the bath increases with proximity to the surface of the component, and promotes attack of the summits of the surface roughness (i.e., the valleys are attacked more slowly than the summits). This phenomenon assists with polishing effect of the surface of the titanium or titanium alloy component by selective dissolution the rough surface areas and minimizes size reduction.

Depending on the variant, the bath has a density ranging from 1.2 to 1.4 g/cm³.

Depending on the variant, the bath is essentially devoid of abrasive particles, in particular the bath is essentially devoid of metal oxide particles, in particular of silica, SiO₂, particles. In the present text, “essentially devoid of” means that no abrasive particles are added to the bath according to the invention. The high concentrations of acids (sulfuric acid and phosphoric acid) together with the presence of fluorides prevent the formation of oxide particles, in particular titanium oxide, TiO₂, particles. However, baths in which particles might form or fluorides might precipitate, for example baths in which titanium fluoride, TiF₄, precipitates might form during use of the bath in a chemical polishing method, are also baths according to the invention. Thus, a chemical polishing bath according to the invention may contain metal fluoride precipitates and be essentially devoid of abrasive particles as defined for the purposes of the invention.

Depending on the variant, no oil, in particular neither mineral oil nor vegetable oil, is added to the present chemical polishing bath (the bath is therefore typically devoid of these compounds). Advantageously, the elevated viscosity of the solution is due solely to the presence in the bath of sulfuric acid, phosphoric acid and titanium.

According to one particularly preferred embodiment, the present polishing bath is aqueous and is essentially composed of sulfuric and phosphoric acids, titanium and the fluoride complexing agent. In other words, the present bath comprises less than 10 mol %, preferably less than 5 mol %, particularly preferably less than 2 mol %, of compounds which are not selected from water, sulfuric acid, phosphoric acid, fluoride complexing agent (in particular fluoride salts), titanium (in particular titanium salts, in particular H₂TiF₆), or mixtures thereof.

In the context of the invention, the above-mentioned concentration ranges should be understood in the broadest possible sense, i.e., including the upper and lower limit values of said concentration ranges. The term “approximately” is used in the present text to signify a range of values of ±10% of the value indicated.

In another aspect, the invention proposes a chemical polishing method for a titanium or titanium alloy component, or a part thereof using the chemical polishing bath as described above.

The method according to the invention comprises at least the following steps:
providing a chemical polishing bath as described above;
immersing a titanium or titanium alloy component to be polished, or a part thereof, in the chemical polishing bath;
removing the component from the bath after a predetermined immersion time.

In order to control the concentration of reagents, in particular (sulfuric and/or phosphoric) acid and complexing agent, in the polishing bath, these concentrations may be determined by assay. The different chemical species may be assayed by acid-base titration in a non-aqueous medium, by thermometric titration or by spectrophotometry. Alternatively, the various reagents may also be assayed by ionic chromatography or by inductively coupled plasma atomic emission spectrometry (ICP-AES).

The temperature of the polishing bath on immersion of the component to be polished is between 30° C. and 60° C., preferably between 40° C. and 50° C. The immersion time of the titanium or titanium alloy component in the polishing bath is between 20 and 60 minutes, preferably between 30 and 50 minutes. The temperature of the bath influences the reaction kinetics of the polishing method, and in particular the speed of attack of the titanium. The higher the temperature, the faster the action of the attacking agents (in particular sulfuric acid and/or phosphoric acid) and complexing agents. The difference between the reaction rate of the reagents and the diffusion thereof is accentuated, which improves the polishing method and the results obtained, i.e., a decrease in surface roughness while limiting size reduction.

Thanks to the method according to the invention using the polishing bath at a certain temperature and by immersing the component or the part thereof to be polished for a particular period, the surface roughness of the component can be significantly diminished without any great increase in size reduction. These two effects generally require conflicting parameters: immersing a titanium or titanium alloy component longer in the polishing bath makes it possible to promote the decrease in roughness but increases the size reduction. Surprisingly, applying an immersion time of 20 minutes makes it possible to achieve an arithmetic mean residual roughness, or height, on a surface (Sa) of less than 5 μm, and even of less than 3 or 2 μm, while limiting the size reduction to around one hundred micrometers. In other words, in the present context, the size reduction observed for a component polished with the assistance of a chemical polishing bath or a chemical polishing method according to the invention amounts to a size reduction of less than 300 to 350 μm. The parameter Sa may be considered more relevant than Ra when it comes to quantifying roughness, or a decrease in roughness, of a surface because said parameter is an arithmetic mean roughness measured over a surface and not just along a line like Ra.

Furthermore, the titanium or titanium alloy components polished with the assistance of a chemical polishing bath according to the invention also advantageously have a maximum residual roughness, or height, on a surface (Sz) of less than 50 μm, and even of less than 40 μm.

Advantageously, a degreasing and/or chemical pickling step may be performed on the surface of the component to be polished prior to the step of immersing said component or the part thereof to be polished in the chemical polishing bath. Particularly advantageously, the chemical polishing bath is sufficiently aggressive to remove any residual oxide formed on the surface of the component to be polished, and a degreasing step is sufficient to enable treatment of the component to be polished using the method according to the invention. Such a surface preparation step makes it possible to clean the surface, in particular to remove any greasy substances deposited on the surface of the component to be treated during handling, and in particular to facilitate access thereto by the acids (enabling, inter alia, surface oxidation) and/or complexing agents reacting with said surface during the chemical polishing process, so boosting its effectiveness.

The chemical polishing bath according to the invention or the method using such a bath, are particularly well suited to titanium alloys.

The present chemical polishing bath together with the present polishing method were in particular developed for processing components made of titanium of allotropic alpha, beta or two-phase alpha-beta form or of titanium alloy of alpha, near-alpha, beta, near-beta or two-phase alpha-beta form, in particular the titanium alloys may be the alloys TA6V, T40, TV10A3Fe2, Ti6242, β21, β21S, Ti 555-3, more particularly the titanium alloy is alloy TA6V or alloy T40, commonly used in industry and in additive manufacturing.

Advantageously, the part to be polished in whole or in part with the assistance of a chemical polishing bath according to the invention or of the method using such a bath is a titanium or titanium alloy component obtained by an additive manufacturing method, or 3D printing, method.

Accordingly, the present chemical polishing bath or the present chemical polishing method is in particular applied to the treatment of components produced for the aerospace, aeronautical and automotive industries, in order to eliminate surface irregularities and thus prevent the risk of particles becoming separated from the surface of said components in service, which could give rise to functional problems in connection with their use, such as pipework blockages or a decrease in their static and/or dynamic mechanical properties.

### BRIEF DESCRIPTION OF THE FIGURES

Other details and features of the invention will emerge from the following detailed description of at least one advantageous embodiment, provided below by way of illustration with reference to the appended drawings, in which:

FIG. 1 shows diagrams representing (points 1 to 6) of the principle of operation of the present method;

FIG. 2 shows confocal micrographs that enable a comparison of the surface state of a component made of titanium alloy TA6V after immersion in a chemical polishing bath according to a first embodiment of the present invention for 0 min (a), 1 min (b), 2 min (c), 10 min (d), 20 min (e) and 30 min (f);

FIG. 3 is a graph showing the change in roughness Sa (roughness against time) for a sample immersed in a chemical polishing bath according to a first embodiment of the present invention for different times;

FIG. 4 is a graph showing the change in roughness Sz (roughness against time) for a sample immersed in a chemical polishing bath according to a first embodiment of the present invention for different times;

FIG. 5 is a graph showing the change in roughness Sz (size reduction against time) for a sample immersed in a chemical polishing bath according to a first embodiment of the present invention for different times; and

FIG. 6 is a graph showing the change in both Sa, Sz roughness values and size reduction (Sa, Sz, size reduction against titanium concentration) for different samples immersed in chemical polishing baths according to other embodiments of the present invention.

### DETAILED DESCRIPTION WITH REFERENCE TO THE EXAMPLES

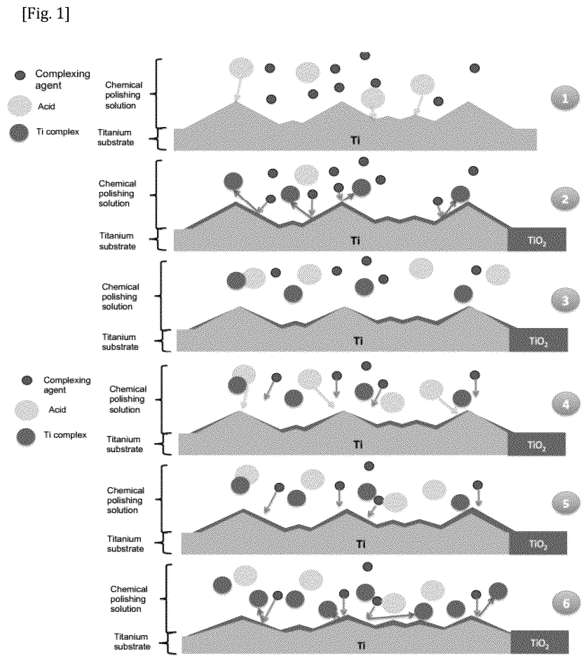

The principle of operation of the polishing bath according to the invention will firstly be explained with reference to FIG. 1. As explained previously, the present invention surprisingly proposes a polishing bath which allows roughness to be significantly diminished, without increasing size reduction, whereas these two effects generally require conflicting parameters.

The increased viscosity of the bath, which is controlled by the sulfuric and phosphoric acids, makes it possible to slow the diffusion phenomena of the chemical species of the solution toward the surface of the component. This depletion of active species on the surface, due to their being consumed in the vicinity of the surface, is responsible for a surface polishing effect by selective dissolution of the surface relief.

The principle is shown in FIG. 1:
1): attack and oxidation of the material by the sulfuric and phosphoric acids and formation a first passivation layer (metal oxides formed from titanium and alloy elements where applicable);
2, 3): complexation of titanium oxides, and of the alloy oxides where applicable, by complexing agents to solubilize the oxides;
4, 5): slow diffusion of the sulfuric and phosphoric acids (enabling inter alia surface oxidation) from the solution toward the surface of the alloy to be polished, the elevated density of the polishing bath slowing down the arrival of the oxidizing compounds (sulfuric and phosphoric acids);
6): attack of the upper parts of the relief, bringing about the reduction in roughness.

### EXAMPLES

Nine examples of polishing titanium components in nine different baths, baths 1 to 9, according to the invention, together with four examples of treating titanium components in four different baths, baths 10 to 13, not according to the invention (comparative examples).

Thirteen TA6V titanium alloy components denoted A to M resulting from the same additive manufacturing method each take the form of a plate of dimensions 40×20 mm. The upper side is the side on which the layers of material are added one after the other during the manufacturing method, while the lower side is the opposite side. The upper side of each of the components typically has a roughness Sa of the order of 30 μm and a roughness Sz of the order of 300 μm.

Components A and J to M to L first underwent a degreasing step in order to prepare their surface using a conventional method familiar to a person skilled in the art. Components B to I did not undergo a surface preparation step. The thirteen components A to M were then each partially covered with self-adhesive masking tape.

The resultant partially masked titanium alloy components A to I were then subjected to chemical polishing methods using polishing baths of different compositions, denoted 1 and 9, according to 9 preferred but non-limiting embodiments of the invention. Moreover, the resultant partially masked titanium alloy components J to M were then subjected to chemical polishing methods using comparative polishing baths of different compositions, denoted 10 to 13, that were not according to the invention. The thirteen different baths 1 to 13 were prepared in similar tanks with solution volumes of 1 L; their compositions are set out in Table 1. The baths corresponding to the counter-examples are indicated with an asterisk, *, in Table 1.

All the baths were maintained at a temperature of 40° C.

The titanium alloy component A was immersed in bath 1 for a time varying between 1 minute and 30 minutes. In particular, observations of the surface of component A were made after immersion times of 1 minute, 2 minutes, 10 minutes, 20 minutes and 30 minutes.

Titanium alloy component B was immersed in bath 2, component C was immersed in bath 3, component D was immersed in bath 4, component E was immersed in bath 5, component F was immersed in bath 6, component G was immersed in bath 7, component H was immersed in bath 8, component I was immersed in bath 9, component J was immersed in bath 10, component K was immersed in bath 11, component L was immersed in bath 12 and component M was immersed in bath 13.

Each of components B to M was immersed for 50 min in baths 2 to 13 respectively.

For each of the components, the zone covered by the self-adhesive masking tape was not in direct contact with the bath in which the component was immersed and did not undergo any change in its surface state.

TABLE 1

| | | | | | | | | | Equivalent | | | | |
|---|---|---|---|---|---|---|---|---|---|---|---|---|---|
| | H₂SO₄ | | H₃PO₄ | | Titanium | | NH₄F•HF | | fluoride | | Immersion | | Size |
| | g/L | | g/L | | g/L | | g/L | | concentration | | time | Sa | reduction |
| Bath | (mol/L) | | (mol/L) | | (mol/L) | | (mol/L) | | mol/L | Component | (min) | (μm) | (μm) |
| Bath 1 | 100 | (1.02) | 380 | (3.9) | 2 | (0.04) | 63 | (1.11) | 2.22 | A | Variable | 4.57 ± 0.05 | 110 ± 20 |
| Bath 2 | 100 | (1.02) | 380 | (3.9) | 3 | (0.06) | 63 | (1.11) | 2.22 | B | 50 | 4.2 ± 0.4 | 120 ± 3 |
| Bath 3 | 100 | (1.02) | 380 | (3.9) | 5 | (0.1) | 63 | (1.11) | 2.22 | C | 50 | 4.7 ± 0.7 | 144 ± 20 |
| Bath 4 | 100 | (1.02) | 380 | (3.9) | 7 | (0.14) | 63 | (1.11) | 2.22 | D | 50 | 3.8 ± 0.9 | 100 ± 10 |
| Bath 5 | 100 | (1.02) | 380 | (3.9) | 10 | (0.21) | 63 | (1.11) | 2.22 | E | 50 | 3.5 ± 0.6 | 140 ± 30 |
| Bath 6 | 100 | (1.02) | 380 | (3.9) | 15 | (0.31) | 63 | (1.11) | 2.22 | F | 50 | 3.3 ± 0.5 | 130 ± 20 |
| Bath 7 | 100 | (1.02) | 380 | (3.9) | 20 | (0.41) | 63 | (1.11) | 2.22 | G | 50 | 3.2 ± 0.3 | 130 ± 10 |
| Bath 8 | 100 | (1.02) | 380 | (3.9) | 28 | (0.58) | 63 | (1.11) | 2.22 | H | 50 | 2.9 ± 0.1 | 120 ± 20 |
| Bath 9 | 100 | (1.02) | 380 | (3.9) | 34 | (0.71) | 63 | (1.11) | 2.22 | I | 50 | 2.95 ± 0.05 | 130 ± 2 |
| Bath 10 * | 98 | (1) | 0 | (0) | 5 | (0.1) | 34 | (0.6) | 1.2 | J | 50 | 6.6 ± 0.1 | 1200 ± 100 |
| Bath 11 * | 686 | (7) | 0 | (0) | 5 | (0.1) | 34 | (0.6) | 1.2 | K | 50 | 12.7 ± 0.5 | 600 ± 100 |
| Bath 12 * | 588 | (6) | 0 | (0) | 5 | (0.1) | 68 | (1.2) | 2.4 | L | 50 | 19.2 ± 0.5 | 400 ± 100 |
| Bath 13 * | 98 | (1) | 882 | (9) | 5 | (0.1) | 68 | (1.2) | 2.4 | M | 50 | 7.7 ± 0.4 | 280 ± 30 |

For the purposes of the present invention, since the elevated viscosity of the polishing bath (typically a density of 1.2 to 1.4 g/cm³) and the local non-uniformities in concentration (due to the thickness of the diffusion layer) of oxidizing agent and complexing agent are crucial to controlling polishing and promoting chemical attack of the peaks, agitation of the bath when the component to be treated is immersed therein is strictly controlled. The bath may for example be agitated by recirculating it at a rate such as the bath is changed two to three times per hour.

The bath is preferably agitated at a lower agitation rate when the component to be polished is immersed (treatment phase) than during preparation of the polishing bath (homogenization phase). This agitation rate is typically between 5 and 10 L/min during the treatment phase and around 100 L/min during homogenization phases. These agitation rate values are given solely by way of example and do not limit the present invention. In particular, since the agitation rate influences the renewal of chemical species present in the liquid layer, known as the diffusion layer, in the vicinity of the component to be treated, a lower agitation rate enables the formation of a thicker diffusion layer, which slows the diffusion of reactants and promotes polishing.

After immersion in the polishing bath, each of the treated components was rinsed and then observed under a confocal microscope in order to determine the decrease in its roughness and its size reduction. In particular, for each of the components, the self-adhesive masking tape was removed and a zone comprising a treated surface and an untreated surface (because it had previously been masked by the self-adhesive masking tape) was observed using an Olympus DSX510 confocal microscope. The topography of each of the components (upper side and, for certain components, also the lower side) was recorded and analyzed in order to establish the size reduction due to material removal and the variations in roughness parameters due to the polishing effect of the different baths, in particular the variations in Sa and Sz.

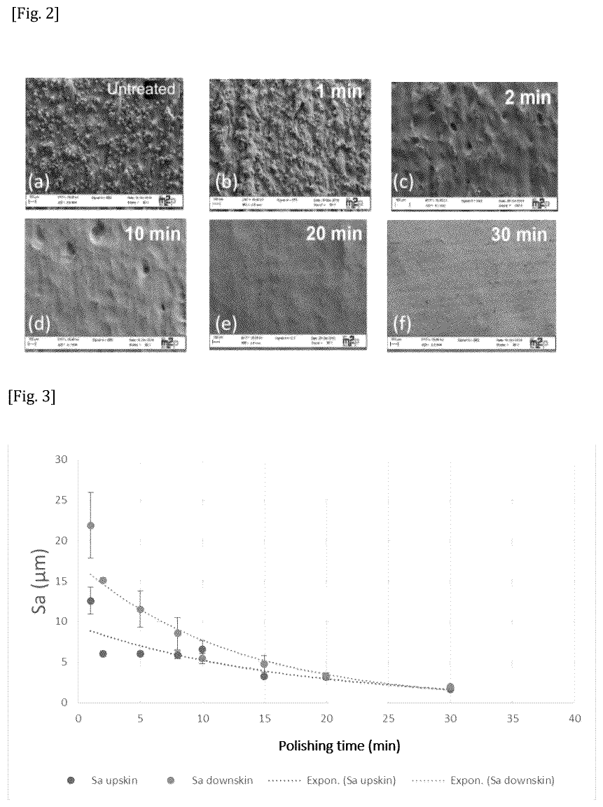

The surface roughness values obtained on completion of the chemical polishing (treated surface) for titanium alloy components A to I treated with the assistance of baths according to the invention, together with the size reduction of the components that had taken place during this polishing are set out in Table 1 and in FIGS. 2 to 6. Table 1 sets out the surface roughness values obtained on completion of the chemical polishing (treated surface) for titanium alloy components J to M treated with the assistance of baths that are not according to the invention, together with the size reduction of the components that had taken place during this polishing.

All of components A to M obtained by a substantially identical manufacturing method had a similar surface state before polishing, with an Sa of the order of 30 μm and an Sz of the order of 200 μm.

We will initially look only at component A, which was immersed in bath 1 for varying lengths of time. FIG. 2a is a photograph of the surface before polishing. FIG. 2b is a photograph of component A after 1 minute's immersion in bath 1, FIG. 2c corresponds to component A after 2 minutes' immersion, FIG. 2d to component A after 10 minutes' immersion, FIG. 2e to component A after 20 minutes' immersion and FIG. 2f to component A after 30 minutes' immersion. The microscopic observations shown in FIG. 2 clearly reveal the effectiveness of the polishing baths according to the invention with regard to removing partially melted particles present on the surface of the samples. Indeed, no spherical particles are observed on their surface after processing (FIG. 2f, component A, 30 minutes' immersion), despite their initial size of the order of tens of microns in the case of the selective laser melting (SLM) additive manufacturing method (FIG. 2a).

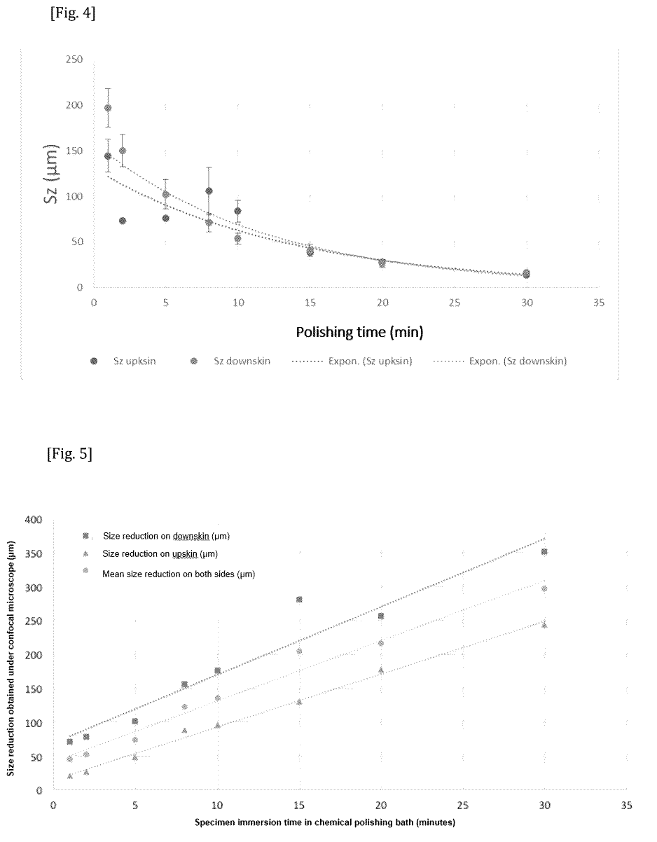

After polishing, component A underwent a size reduction of each of its sides (FIG. 5), this occurring after just 1 minute's immersion in bath 1. FIGS. 3 and 4 show a sharp reduction in the surface relief of the component treated by bath 1 according to the invention, and therefore polishing of component A. Increasing the immersion time in the polishing bath improves the reduction in surface roughness on both the upper and lower sides (FIGS. 3 and 4), but also increases the size reduction of each side (FIG. 5). Furthermore, the average surface roughness Sa after polishing chemical is between 2 and 3 μm at the end of 30 minutes' processing, irrespective of the initial roughness of the samples. It should be noted that the final roughness Sa would appear to tend toward a limit of approximately 2-3 μm whatever the manufacturing orientation (i.e., whether the upper or lower side is considered), while size reduction continues to increase. There is no need to immerse the components to be treated in the polishing bath according to the invention for too long in order to achieve the desired polishing effect. However, a person skilled in the art will realize that the average rate of attack is 10 μm/min, namely 300 μm of size reduction per side in 30 minutes' immersion in a bath according to the invention, which is half the size reduction obtained with chemical machining methods.

The polishing bath developed here also makes it possible to significantly reduce the roughness parameter Sz (FIG. 4). The change is similar to that in Sa with values of less than 20 μm after 30 minutes' treatment.

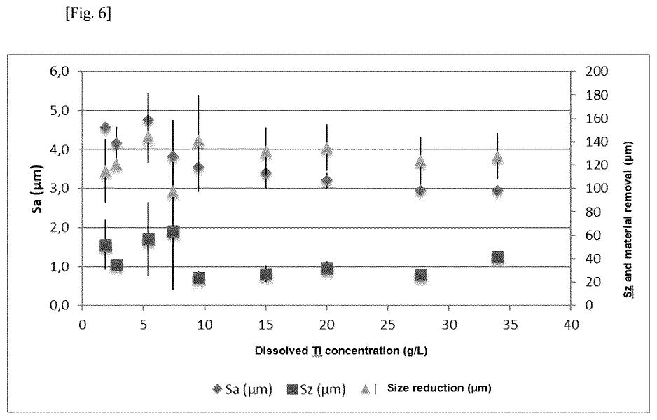

If we now turn to components B to I, these were immersed for a substantially identical time in baths that differed from one another in the initial quantity of titanium they contained. The observations made related solely to the upper side and revealed a significant reduction in Sa and Sz surface roughness values (FIG. 6). Indeed, before treatment, the components had an Sa of the order of 30 μm and, after treatment, an Sa of less than 5 μm whichever bath (2 to 9) was used, while roughness Sz was reduced from approximately 200 μm to less than 70 μm. Size reduction was limited to values of less than 150 μm, which corresponds to typical material removal during a polishing method, in comparison with a machining method. The results presented in FIG. 6 indicate that the effectiveness of a polishing bath according to the invention is optimal for titanium concentrations of between 10 and 35 g/L.

If the results obtained with the assistance of bath 3 (according to the invention) and bath 13 (comparative example) are compared, it will be noted that increasing the concentration of phosphoric acid brings about a greater size reduction and a lesser reduction in surface roughness (Table 1). If the results obtained with the assistance of bath 3 (according to the invention) and baths 10 and 12 (comparative examples) are compared, it will also be noted that simultaneously reducing the concentration of phosphoric acid and increasing the concentration of sulfuric acid (bath 12) or reducing the concentration of fluoride complexing agent (bath 10) also results in a greater size reduction and a lesser reduction in surface roughness (Table 1). The size reduction of each of components J and L is more than twice that of component C treated by bath 3 (according to the invention). Baths 10 and 12 are chemical machining baths and not chemical polishing baths.

1.-15. (canceled)

16. A chemical polishing bath for polishing a titanium or titanium alloy component, or a part thereof, said chemical polishing bath comprising:
water,
a fluoride complexing agent capable of forming a complex with oxidized titanium at an equivalent fluoride concentration of between 1.40 and 2.80 mol/L;
phosphoric acid in a concentration of between 3.0 and 6.0 mol/L; and
sulfuric acid in a concentration of between 0.5 and 1.5 mol/L.

17. The chemical polishing bath as claimed in claim 16, wherein the fluoride complexing agent is added to the bath in the form of NH₄F, NH₄F·HF, NaF, NaF·HF, KF, KF·HF, H₂SiF₆, H₂TiF₆ or a mixture of two or more thereof.

18. The chemical polishing bath as claimed in claim 16, wherein the fluoride complexing agent is present such that a concentration of fluoride is between 1.74 and 2.46 mol/L.

19. The chemical polishing bath as claimed in claim 16, wherein the phosphoric acid is present in a concentration of between 4.0 and 5.5 mol/L.

20. The chemical polishing bath as claimed in claim 16, wherein the sulfuric acid is present in a concentration of between 0.5 and 1.25 mol/L.

21. The chemical polishing bath as claimed in claim 16, wherein the chemical polishing bath has a pH of less than 2.0.

22. The chemical polishing bath as claimed in claim 21, wherein the pH of the chemical polishing bath is negative.

23. The chemical polishing bath as claimed in claim 16 comprising titanium, present in a concentration ranging from approximately 2 to 35 g/L, namely between approximately 0.04 and 0.73 mol/L.

24. The chemical polishing bath as claimed in claim 16, said bath having a density ranging from 1.2 to 1.4 g/cm³.

25. The chemical polishing bath as claimed in claim 16, said bath being essentially devoid of abrasive particles.

26. The chemical polishing bath as claimed in claim 16, wherein no oil is added.

27. The chemical polishing bath as claimed in claim 16, wherein neither mineral oil nor vegetable oil is added.

28. The chemical polishing bath as claimed in claim 16, wherein the titanium or titanium alloy component to be polished is obtained by an additive manufacturing method.

29. The chemical polishing bath as claimed in claim 16, wherein the component to be polished, or the part thereof, is made of titanium of allotropic alpha, beta or two-phase alpha-beta form, or of titanium alloy of alpha, near-alpha, beta, near-beta or two-phase alpha-beta form, or of an alloy selected from TA6V, T40, TV10A3Fe2, Ti6242, β21, β21S, Ti 555-3.

30. A chemical polishing method for polishing a titanium or titanium alloy component, or a part thereof, comprising the following steps:
(i) providing a chemical polishing bath as claimed in claim 16;
(ii) immersing a titanium or titanium alloy component to be polished, or a part thereof in the chemical polishing bath;
(iii) removing the component after a predetermined immersion time.

31. The chemical polishing method as claimed in claim 30, wherein the chemical polishing bath is maintained at a temperature of between 30° C. and 60° C.

32. The chemical polishing method as claimed in claim 30, wherein the immersion time is between 20 and 60 minutes.

33. The chemical polishing method as claimed in claim 30, wherein the titanium or titanium alloy component, or the part thereof, to be polished is subjected to a degreasing and/or chemical pickling step before being immersed in the chemical polishing bath.

34. The chemical polishing method as claimed in claim 30, wherein the component to be polished, or the part thereof, is made of titanium of allotropic alpha, beta or two-phase alpha-beta form, or of titanium alloy of alpha, near-alpha, beta, near-beta or two-phase alpha-beta form, or of an alloy selected from TA6V, T40, TV10A3Fe2, Ti6242, β21, β21S, Ti 555-3.

35. The chemical polishing method as claimed in claim 30, wherein the titanium or titanium alloy component to be polished is obtained by an additive manufacturing method.
